(19) United States
(12) Patent Application Publication
(10) Pub. No.: US 2022/0025735 A1
(43) Pub. Date: Jan. 27, 2022

(54) REDUCING ASPHALTENES IN PRODUCED FLUIDS FROM A WELLBORE

(71) Applicant: CHEVRON U.S.A. INC., San Ramon, CA (US)

(72) Inventor: Andrew OGHENA, The Woodlands, TX (US)

(73) Assignee: CHEVRON U.S.A. INC., San Ramon, CA (US)

(21) Appl. No.: 16/937,720

(22) Filed: Jul. 24, 2020

(51) Int. Cl. E21B 37/06; E21B 47/00; E21B 43/12; C09K 8/536; C09K 8/524

(52) U.S. Cl. CPC E21B 37/06; E21B 47/006; C09K 2208/10; C09K 8/536; C09K 8/524; E21B 43/123

(57) ABSTRACT

Embodiments of reducing asphaltenes in produced fluids from a wellbore are provided herein. One embodiment comprises injecting a combination of gas and coated nanoparticles into a wellbore during a gas lift operation. The coated nanoparticles adsorb asphaltenes in the wellbore, thereby inhibiting asphaltene deposition, reducing asphaltene molecule interaction, reducing agglomeration of asphaltenes, or any combination thereof. The embodiment further comprises recovering produced fluids through the wellbore.

### TECHNICAL FIELD

The present disclosure generally relates to reducing asphaltenes in produced fluids from a wellbore.

### BACKGROUND

Reservoir systems, such as petroleum reservoirs, typically contain fluids such as water and a mixture of hydrocarbons such as oil and gas. To remove (“produce”) the hydrocarbons from the reservoir, different mechanisms can be utilized such as primary depletion, artificial lift, secondary or tertiary processes. In a primary recovery process, hydrocarbons are displaced from a reservoir through the high natural differential pressure between the reservoir and the bottom-hole pressure within a wellbore. In order to increase the production life of the reservoir, artificial lift, secondary or tertiary recovery processes can be used (“improved oil recovery” or IOR, or “enhanced oil recovery” or EOR). Secondary recovery processes include continuous water or gas (e.g., N₂ natural gas, and/or CO₂) well injection or combination of both water and gas, steam injection, and/or injecting additional chemical compounds into the reservoirs such as surfactants and polymers, while tertiary methods are based on secondary water injection followed by gas injection or chemical injection for additional recovery.

Asphaltene precipitation, flocculation, and subsequent deposition can occur in the reservoir, wellbore, and/or surface flowlines during hydrocarbon related operations. For example, asphaltene precipitation and deposition during wellbore flow from reservoir sand face to wellhead is caused by the changes of pressure and temperature during vertical flow from the bottomhole through the production tubing to the wellhead at the surface. Asphaltene precipitation will occur when the pressure of the fluid flowing in the production tubing is below the Asphaltene Onset Pressure (AOP). Laboratory investigations can be used to determine AOP.

Although there are well-known remediation methods for mitigating asphaltene deposition (e.g., via chemical injection, mechanical, or thermal operations in the well), there continues to be a need for improved methods to mitigate asphaltene deposition. This is due to the fact that conventional asphaltene mitigation methods do not yield long lasting remediation of the asphaltene issue.

### SUMMARY

Embodiments of reducing asphaltenes in produced fluids from a wellbore are provided herein.

One embodiment of a method of reducing asphaltenes in produced fluids from a wellbore is provided herein. The embodiment includes injecting a combination of gas and coated nanoparticles into a wellbore during a gas lift operation. The coated nanoparticles adsorb asphaltenes in the wellbore, thereby inhibiting asphaltene deposition, reducing asphaltene molecule interaction, reducing agglomeration of asphaltenes, or any combination thereof. The embodiment includes recovering produced fluids through the wellbore.

One embodiment of a system of reducing asphaltenes in produced fluids from a wellbore is provided herein. The embodiment includes a wellbore drilled into a subsurface, and a combination of gas and coated nanoparticles injected into the wellbore during a gas lift operation. The coated nanoparticles adsorb asphaltenes in the wellbore, thereby inhibiting asphaltene deposition, reducing asphaltene molecule interaction, reducing agglomeration of asphaltenes, or any combination thereof. Produced fluids are recovered through the wellbore.

### DESCRIPTION OF THE DRAWINGS

FIG. 1 illustrates one embodiment of a method of reducing asphaltenes in produced fluids from a wellbore.

FIG. 2A illustrates one embodiment of a gas lift system with a wellbore having a vertical trajectory.

FIG. 2B illustrates the gas lift system of FIG. 2A with one embodiment of a chemical injection tubing.

FIG. 2C illustrates the gas lift system of FIG. 2A with a wellbore having a horizontal trajectory.

FIG. 3 illustrates an embodiment of a method of asphaltene surveillance.

Reference will now be made in detail to various embodiments, where like reference numerals designate corresponding parts throughout the several views. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatuses have not been described in detail so as not to unnecessarily obscure aspects of the embodiments. Those of ordinary skill in the art will appreciate that the figures are not drawn to scale.

### DETAILED DESCRIPTION

TERMINOLOGY: As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

“Hydrocarbon-bearing formation” or “formation” or “reservoir” refer to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area). The formation may include hydrocarbons. The formation may also be divided up into one or more hydrocarbon zones, and hydrocarbons can be produced from each desired hydrocarbon zone. The terms are not limited to any embodiments provided herein.

“Hydrocarbon” or “hydrocarbonaceous” or “petroleum” or “crudes” or “crude oil” or “oil” or “natural gas” may be used interchangeably to refer to carbonaceous material originating from subterranean sources as well as synthetic hydrocarbon products, including organic liquids or gases, kerogen, bitumen, crude oil, natural gas or from biological processes, that is principally hydrogen and carbon, with significantly smaller amounts (if any) of heteroatoms such as nitrogen, oxygen and sulfur, and, in some cases, also containing small amounts of metals. One measure of the heaviness or lightness of a liquid petroleum is American Petroleum Institute (API) gravity. According to this scale, light crude oil is defined as having an API gravity greater than 31.1° API (less than 870 kg/m3), medium oil is defined as having an API gravity between 22.3° API and 31.1° API (870 to 920 kg/m3), heavy crude oil is defined as having an API gravity between 10.0° API and 22.3° API (920 to 1000 kg/m3), and extra heavy oil is defined with API gravity below 10.0° API (greater than 1000 kg/m3). Light crude oil, medium oil, heavy crude oil, and extra heavy crude oil are examples of hydrocarbons. The terms are not limited to any embodiments provided herein.

“Well” and “wellbore” are used interchangeably to denote a borehole extending from the earth surface to a subterranean formation and at least partially in fluid communication with a reservoir. The wellbore may include casing, liner, tubing, other items, or any combination thereof. The wellbore may be vertical, inclined, horizontal, combination trajectories, etc. The wellbore may include any completion hardware that is not discussed separately. As discussed herein, the wellbore will be utilized during a gas lift operation. A “production well” or “production wellbore” enables the removal of fluids from the formation to the surface through a production tubing. The wellbore utilized during the gas lift operation may be referred to as a production wellbore. The terms are not limited to any embodiments provided herein.

“Asphaltenes” or “asphaltene” are defined as the fraction of oil, bitumen, or vacuum residue that is insoluble in low-molecular-weight paraffins, such as n-heptane or n-pentane, yet is soluble in light aromatic hydrocarbons such toluene, pyridine, or benzene. Asphaltenes have a tendency to form colloidal aggregates and to stick onto production tubing surfaces. In one embodiment, the asphaltenes structure is formed by polyaromatic cores attached to aliphatic chains containing heteroatoms, such as nitrogen, oxygen, and sulfur, in addition to metals such as vanadium and nickel. The terms are not limited to any embodiments provided herein.

“Gas” refers to a gas that will be injected into the wellbore during the gas lift operation. As discussed herein, the gas may be injected without coated nanoparticles during the gas lift operation, the gas may be injected with coated nanoparticles into the wellbore during the gas lift operation, or any combination thereof. If coated nanoparticles are injected, the gas that is injected with the coated nanoparticles should be adequate to suspend the coated nanoparticles during the gas lift operation (e.g., the coated nanoparticles are suspended in the gas from entering the wellbore through an injection string into the annulus to exiting the wellbore).

In one embodiment, injecting a combination of gas and coated nanoparticles into the wellbore during the gas lift operation comprises injecting the combination of gas and coated nanoparticles into an annulus of the wellbore. The injected combination of gas and coated nanoparticles flows into a production tubing of the wellbore from the annulus of the wellbore via at least one flow valve of the production tubing of the wellbore. The annulus is located between the production tubing of the wellbore and casing of the wellbore.

Practically any gas that may be injected into the annulus of the wellbore may be utilized. The gas may comprise produced gas, carbon dioxide, natural gas, methane, ethane, nitrogen, propane, butane, flue gas, exhaust gas, or any combination thereof. The gas being used in the gas lift operation may also be utilized for injection of the coated nanoparticles. Of note, natural gas, carbon dioxide, nitrogen, or any combination thereof may be injected (with or without coated nanoparticles) under critical or supercritical condition such that the injection gas is a dense fluid. The terms are not limited to any embodiments provided herein.

In one embodiment, the gas and the coated nanoparticles may already be combined when they enter the wellbore, such as enter through an injection string of the wellhead of the wellbore. Before entering the injection string, a first source (e.g., a first tank) on the surface may store the gas without the coated nanoparticles and a different second source (e.g., a second tank) on the surface may store the coated nanoparticles. The coated nanoparticles can be pre-mixed with the gas in any of continuous or batch mode prior to injection, in high pressure tanks at topside/surface facilities before going into the injection string. In another embodiment, the coated nanoparticles in concentrated liquid form are mixed on the fly, or co-injected with the gas with or without an inline mixer.

“Nanoparticles” or “nano particles” generally refer to particles having a size of less than 100 nm (i.e., less than or equal to 0.1 μm). For example, the nanoparticles are characterized as: 1) having large surface to volume ratio; 2) having a high degree of suspension in a fluid (e.g., gas under supercritical condition) (e.g., high degree of suspension in a fluid is dependent on the nanoparticles being used and refers to a sufficient amount of suspension so that the nanoparticles being used do not flocculate, drop, and attached to the walls of the producing tubing); 3) having absorption capacity and being catalytically active; 4) can be acidic, basic, or neutral; or any combination thereof.

The combination of gas and coated nanoparticles may be injected into the wellbore. In one embodiment, the coated nanoparticles are surface coated with an acidic coating. In one embodiment, the coated nanoparticles are surface coated with a basic coating. In one embodiment, the coated nanoparticles are surface coated with a neutral coating. In one embodiment, the coated nanoparticles comprise iron oxide, magnetite, iron octanoate, or any combination thereof, wherein each of the coated nanoparticles is coated by functionalizing with alkylphenol resins, aldehyde resins, sulfonated resins, polyolefin esters, amides, imides with alkyl, alkylenephenyl functional group, alkylenepyridyl functional groups, alkenyl and vinylpyrrolidone copolymers, graft polymers of polyolefins, hyperbranched polyester amides, lignosulfonates, alkylaromatics, alkylaryl sulfonic acids, phosphoric esters, phosphinocarboxylic acids, sarcosinates, amphoteric surfactants, ether carboxylic acids, aminoalkylene carboxylic acids, alkylphenols and ethoxylates, imidazolines and alkylamide-imidazolines, alkylsuccinimides, alkylpyrrolidones, fatty acid amides and ethoxylates thereof, fatty esters of polyhydric alcohols, ion-pair salts of imines and organic acids, triethyl amine groups, triethanolamine lauryl ether sulfate, linear and branched dodecyl benzene sulfonic acid (DBSA), polymers with protic polar heads, or any combination thereof. Practically any coated nanoparticles that may be injected into the annulus of the wellbore may be utilized. More information about coated nanoparticles may be found in U.S. Pat. No. 10,266,750, which is incorporated by reference herein.

In one embodiment, the coated nanoparticles are coated with different inorganic and organic functionalities of various polarities (acidic or base type), allowing the coated nanoparticles to act as inhibitor or dispersant of asphaltenes. Examples of functionalities include alkylphenol or aldehyde resins and similar sulfonated resins, polyolefin esters, amides, or imides with alkyl, alkylenephenyl, or alkylenepyridyl functional groups, alkenyl and vinilpyrrolidone copolymers, graft polymers of polyolefins, hyperbranched polyester amides, lignosulfonates, alkylaromatics, alylaryl sulfonic acids, phosphoric esters, phosphonocarboxylic acids, sarcosinates, amphoteric surfactants, ether carboxylic acids, aminoalkylene carboxylic acids, alkylphenols and ethoxylates, imidazonlines and alkylamide-imidazolines, alkyl succinimides, alkylpyrrolidones, fatty acid amides and their ethoxylates, fatty esters of polyhydric alcohols, ion-pair salts of imines and organic acids, three ethyl amine group such as triethanolamine lauryl ether sulfate, linear and branched dodecyl benzene sulfonic acid (DBSA), polymers with protic polar heads, or any combination thereof.

In one embodiment, the coated nanoparticles are surface coated and/or functionalized. The coated nanoparticles can be coated on all side with the same chemistry in one embodiment, and in another embodiment of a ‘Janus’ type of coating where the one side of particles is more prone to adsorb to rock surface. The coated nanoparticles in one embodiment are chelator-functionalized silica nanoparticles as disclosed in U.S. Pat. No. 8,147,802 B2; having a silica coating for enhanced hydrophilicity as disclosed in U.S. Patent Publication No. 20110033694 A1; polyethylene glycol (PEG) coated silica nanoparticles as disclosed in U.S. Patent Publication No. 20110028662 A1; a functionalized silicate nanoparticle formed as a reaction product of a silicate nanoparticle and an aromatic compound, and a fluid as disclosed in U.S. Patent Publication No. 20140187449 A1; all of the references are incorporated herein by reference in their entirety. Thus, in some embodiments, the nanoparticles are surface coated with a silica coating, a chelator-functionalized silica coating, a polyethylene glycol coating, a functionalized silicate coating, or any combination thereof.

In one embodiment, the coated nanoparticles comprise at least one Group D3 metal oxide nanoparticles supported on alumina nanoparticles, wherein the Group D3 metal is preferably silver, and the weight to weight ratio of alumina nanoparticle to Group D3 metal oxide nanoparticle is in a range of about 80 to 500, and preferably in a range of 99 to about 400. In another embodiment, the coated nanoparticles comprise nickel oxide nanoparticles supported on alumina nanoparticles. In yet another embodiment, the coated nanoparticles may be further coated or impregnated with a Group VIIIB or Group IB metal salt, e.g., palladium, platinum, or iron.

In one embodiment, the coated nanoparticles are of the core-shell nanoparticle type as disclosed in U.S. Pat. No. 8,415,267 B2, incorporated by reference in its entirety. The coated nanoparticles comprise a metal core comprising Mn, Fe, Co, Ni, Cu, Zn, Ru, Rh, Pd, Ag, In, Sn, Re, Os, Ir, Pt, Au, a lanthanoid, alloys thereof, or any combination thereof a metal oxide layer at least partially encapsulating the metal core, wherein the metal oxide layer comprises TiO₂, CeO₂, V₂O₃, ZnO, ZrO₂, SnO₂, WO₃, Fe₂O₃, V₂O₂, MoO₃, or any combination thereof; and a mesoporous silica layer at least partially encapsulating the metal oxide layer. In another embodiment, the coated nanoparticles comprise any of synthetic clay (e.g., laponite), iron zinc sulfide, magnetite, iron octanoate, or any combination thereof.

In one embodiment, the coated nanoparticles are synthesized by a hydrothermal synthesis approach, developed for alumino-silicate gels to obtain commercial zeolite type A. This method employs combination of high concentration of sodium hydroxide with high density gels, allowing the growth of the crystals to be controlled by the polymerization-de-polymerization of the silicate species. The synthesis method further allows surface modification of the nanoparticles to introduce Bronsted acid sites onto the nanoparticle surface, and the incorporation of metals, such as iron, nickel and zirconium.

The coated nanoparticles can also be applied in a dry form, or they can be incorporated in a solution for incorporation into the gas. The solvent solution is prepared by mixing the coated nanoparticles in solution in mixing equipment known in the art, e.g., a high capacity pump or a hydraulic paddle mixer.

In one embodiment, regarding the coated nanoparticles characterized as having large surface to volume ratio, this disclosure includes particle size of 1 nm to 100 nm in a first embodiment; particle size of 1 nm to 90 nm in a second embodiment; particle size of 1 nm to 80 nm in a third embodiment; particle size of 1 nm to 70 nm in a fourth embodiment; particle size of 1 nm to 60 nm in a fifth embodiment; particle size of 1 nm to 50 nm in a sixth embodiment; particle size of 1 nm to 40 nm in a seventh embodiment; particle size of 1 nm to 30 nm in an eighth embodiment; particle size of 1 nm to 20 nm in a ninth embodiment; particle size of 1 nm to 10 nm in a tenth embodiment; particle size of 1 nm to 75 nm in an eleventh embodiment; particle size of 1 nm to 50 nm in a twelfth embodiment; and particle size of 1 nm to 25 nm in a thirteenth embodiment. In yet another embodiment, the coated nanoparticles are defined as having at least one dimension less than 999 nm, discussed further in U.S. Patent Publication No. 2012/0015852, which is incorporated by reference in its entirety. Additionally, the coated nanoparticles can have a surface area of 1 m2/g to 1800 m2/g in one embodiment; 1 m2/g to 1315 m2/g in a second embodiment; 40 m2/g to 300 m2/g in a third embodiment; about 1 m2/g in a fourth embodiment up to about 1315 m2/g in a fifth embodiment; up to about 1800 m2/g in a sixth embodiment, discussed further in U.S. Patent Publication No. 2012/0015852, which is incorporated by reference in its entirety. In some embodiments, the coated nanoparticles may include particles of the same or similar type. In some embodiments, the coated nanoparticles may include particles of different types.

The concentration of the coated nanoparticles in the combination of gas and coated nanoparticles may vary. In one embodiment, the coated nanoparticles are at a concentration of at least 5 ppm in the combination of gas and coated nanoparticles. In one embodiment, the coated nanoparticles are at a concentration ranging from 5 ppm to 200,000 ppm in the combination of gas and coated nanoparticles. In one embodiment, the coated nanoparticles are at a concentration ranging from 5 ppm to 100,000 ppm in the combination of gas and coated nanoparticles. In one embodiment, the coated nanoparticles are at a concentration ranging from 5 ppm to 50,000 ppm in the combination of gas and coated nanoparticles. In one embodiment, the coated nanoparticles are at a concentration ranging from 5 ppm to 10,000 ppm in the combination of gas and coated nanoparticles. In one embodiment, the coated nanoparticles are at a concentration ranging from 50 ppm to 10,000 ppm in the combination of gas and coated nanoparticles. For example, the coated nanoparticles at these concentrations may inhibit aggregation of the asphaltenes, which may result in a reduction of average aggregation size.

The concentration of the coated nanoparticles in the combination of gas and coated nanoparticles may be expressed in weight percent, for example, 0.0005 to 20 weight percent. In one embodiment, the coated nanoparticles are at a concentration of at least 0.001 weight percent in the combination of gas and coated nanoparticles. In one embodiment, the coated nanoparticles are at a concentration ranging from 0.01 to 0.1 weight percent in the combination of gas and coated nanoparticles. In one embodiment, the coated nanoparticles are at a concentration ranging from 0.001 to 0.1 weight percent in the combination of gas and coated nanoparticles. In one embodiment, the coated nanoparticles are at a concentration ranging from 0.5 to 10 weight percent in the combination of gas and coated nanoparticles. In one embodiment, the coated nanoparticles are at a concentration ranging from 1 to 5 weight percent in the combination of gas and coated nanoparticles. In one embodiment, the coated nanoparticles are at a concentration ranging from 0.01 to 5 weight percent in the combination of gas and coated nanoparticles. In one embodiment, the coated nanoparticles are at a concentration ranging from 0.01 to 10 weight percent in the combination of gas and coated nanoparticles.

The quantity of the gas in the combination of gas and coated nanoparticles may depend on the concentration of coated nanoparticles. As one example, (i) the concentration of coated nanoparticles is 1% to 10% (e.g., 5% to 10%) of the combination of gas and coated nanoparticles by weight or volume, and (b) the gas may be 90% to 99% (e.g., 90% to 95%) of the combination of gas and coated nanoparticles by weight or volume. If an additive is also injected with the combination of gas and coated nanoparticles, then the quantity of gas may be decreased to account for the additive. The quantity of gas and the quantity of the coated nanoparticles in the combination of gas and coated nanoparticles may depend on the wellbore design, the quantity of gas needed to suspend the coated nanoparticles during the gas lift operation (e.g., the coated nanoparticles are suspended in the gas from entering the wellbore through an injection string into the annulus to existing the wellbore), the items being injected (e.g., the gas, the coated nanoparticles, and/or the additive), etc.

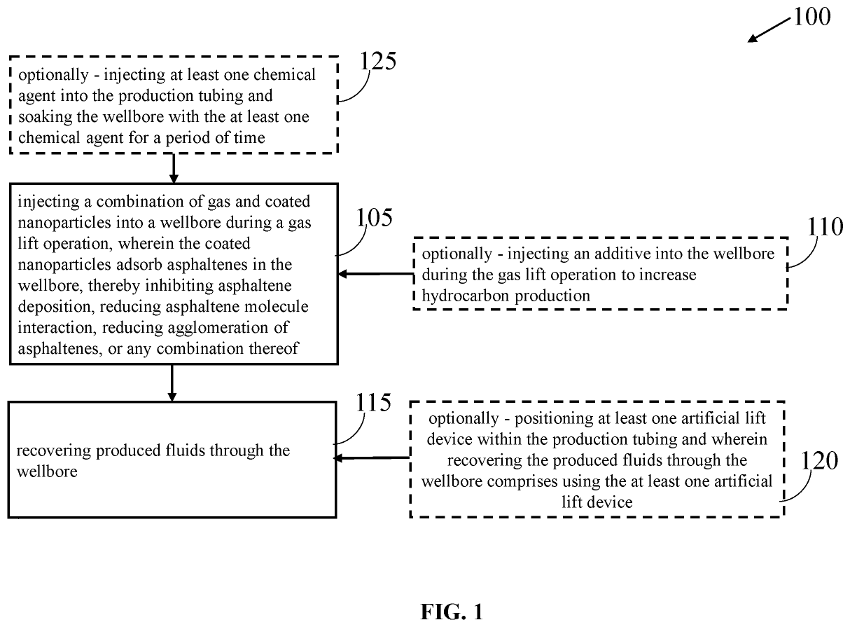

The concentration of the coated nanoparticles in the combination of gas and coated nanoparticles may depend on asphaltene content in the produced fluids. For example, the concentration of the coated nanoparticles may be increased in response to an increase in the asphaltenes content in the produced fluids. The concentration of the coated nanoparticles may be decreased in response to a decrease in the asphaltene content in the produced fluids. As another example, the gas may be injected without the coated nanoparticles during the gas lift operation in response to asphaltene content of zero in the produced fluids. Surveillance data may indicate the asphaltene content in the produced fluids. The surveillance data is discussed further in FIGS. 1, 2A, and 3. The terms are not limited to any embodiments provided herein.

General Process: Although there are well-known remediation methods for mitigating asphaltene deposition (e.g., via chemical injection, mechanical, or thermal operations in the well), there continues to be a need for improved methods to mitigate asphaltene deposition. This is due to the fact that conventional asphaltene mitigation methods, especially for a production wellbore, do not yield long lasting remediation of the asphaltene issue. For example, chemical injection to remediate asphaltenes is typically accomplished through umbilical chemical lines (tubes) with limited capacity for treatment dosage. As another example, for severe wellbore asphaltene deposition, the wellbore is shut-in for soaking and hydrocarbon production is halted while the wellbore is shut-in for soaking. Depending on asphaltene deposition severity, frequent soaking operations may be performed on a single wellbore.

In contrast, the embodiments provided herein relate to injecting a combination of gas and coated nanoparticles during a gas lift operation. The coated nanoparticles adsorb asphaltenes in the wellbore, thereby inhibiting asphaltene deposition, reducing asphaltene molecule interaction, reducing agglomeration of asphaltenes, or any combination thereof. The produced fluids have a reduced concentration of asphaltenes compared to recovery without injection of the coated nanoparticles.

The coated nanoparticles, when combined with gas injection into the producing tubing, may prevent or mitigate the precipitation of asphaltenes. First, the high absorptivity with the ultra-small size of the coated nanoparticles may help to quickly absorb the suspended asphaltene particles in the oil stream. This may improve oil mobility, as well as prevent asphaltene aggregation and coagulation in the production tubing. Second, the coated nanoparticles may affect the interaction between production tubing surface and asphaltene aggregates, which may prevent precipitated and aggregated asphaltenes to interact with minerals on tubing surface and deposit along the tubing surface. This may help vertical oil mobility in the production tubing. Third, for an offshore riser base gas lift operation with asphaltene formation tendency, the combination of gas and coated nanoparticle injection may prevent or mitigate the deposition of asphaltenes. Factors influencing the effectiveness of injecting coated nanoparticles during the gas lift operation may include: contact time, asphaltene weight percent and characteristics, nanoparticle size, fluid composition, temperature, pressure, and other existing downhole wellbore conditions.

Thus, the present disclosure relates to improved methods to mitigate asphaltene formation in oil stream during oil production by using a gas lift operation with a combination of gas injection with coated nanoparticles to mitigate the formation of asphaltenes, thus facilitating improved hydrocarbon recovery processes. Asphaltene formation comprises precipitation, flocculation, deposition, or any combination thereof.

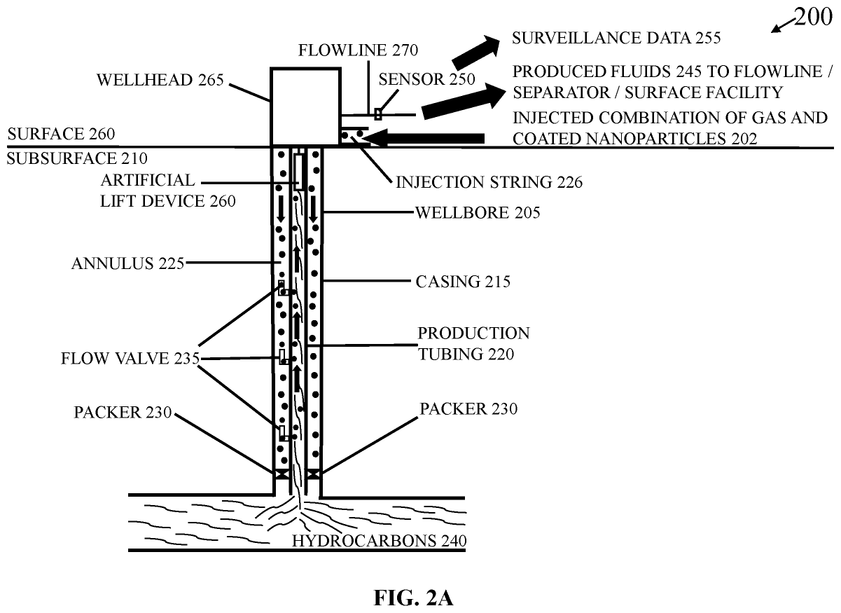

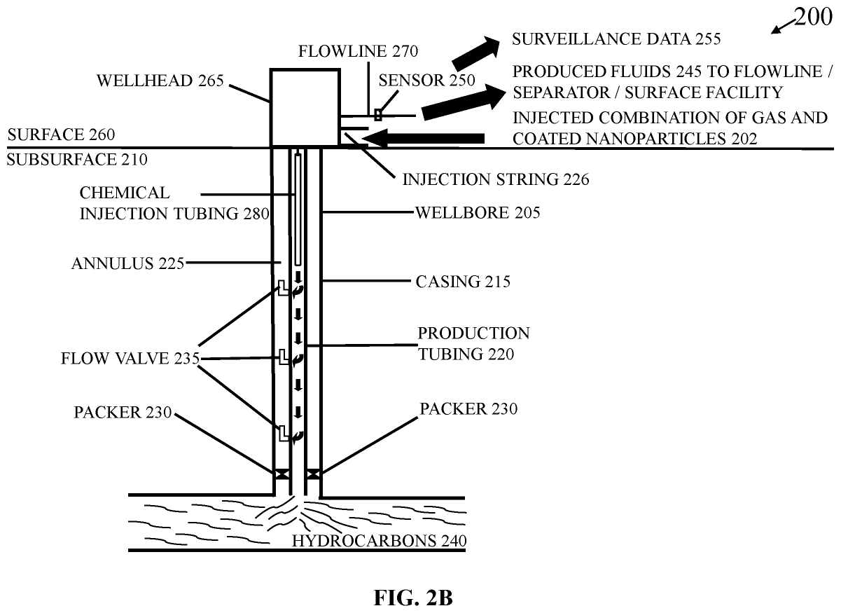

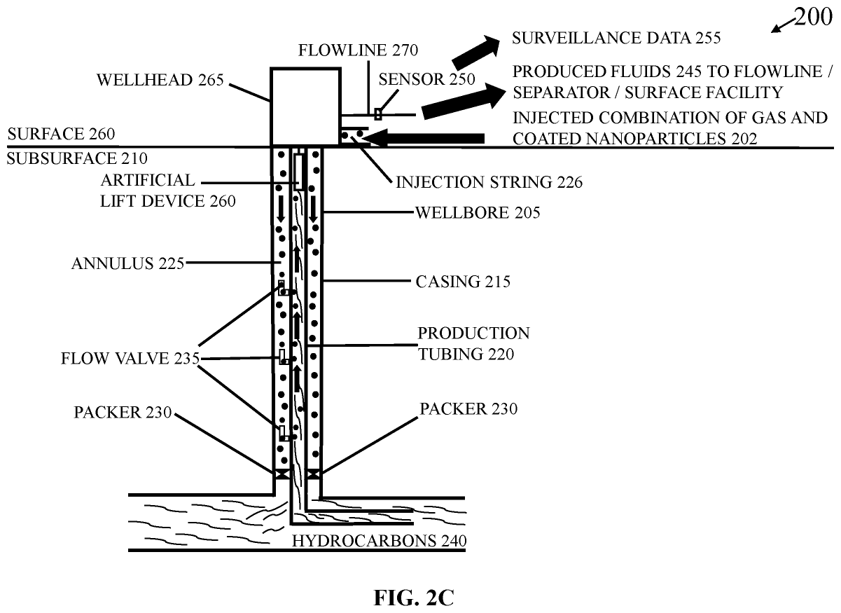

Turning to FIGS. 1 and 2A, FIG. 1 illustrates one embodiment of a method of reducing asphaltenes in produced fluids from a wellbore referred to as a method 100. At 105, the method 100 includes injecting a combination of gas and coated nanoparticles into a wellbore during a gas lift operation. The coated nanoparticles adsorb asphaltenes in the wellbore, thereby inhibiting asphaltene deposition, reducing asphaltene molecule interaction, reducing agglomeration of asphaltenes, or any combination thereof. Some embodiments of the gas are provided in the terminology section hereinabove. Some embodiments of the coated nanoparticles are provided in the terminology section hereinabove.

FIG. 2A illustrates one embodiment of a gas lift system 200 in which a combination of gas and coated nanoparticles 202 (circles) may be injected into a wellbore 205 during a gas lift operation in accordance with 105 of the method 100. The wellbore 205 has a vertical trajectory (sometimes referred to as a vertical wellbore) and it may be drilled into a subsurface 210 using practically any drilling technique and equipment known in the art, such as directional drilling, geosteering, etc. Drilling the wellbore 205 may include using a tool such as a drilling tool that may include a drill bit and a drill string. Drilling fluid may be used while drilling. After drilling to a predetermined depth, the drill string and drill bit are removed, and then the casing, the tubing, etc. may be installed according to the wellbore design. The wellbore 205 is in fluid communication with the subsurface 210 and hydrocarbons 240 therewithin. The combination of gas and coated nanoparticles 202 flow into the wellbore 205 via injection string 226 and produced fluids 245 flow up the wellbore 205 to at least one flowline, at least one separator, a surface facility, etc. on a surface 260. A plurality of the wellbore 205 may be drilled into the subsurface 210, but a single wellbore 205 is illustrated in FIG. 2A for simplicity.

The wellbore 205 may include a casing 215, a production tubing 220, and an annulus 225 between the casing 215 and the production tubing 220. The production tubing 220 may be of standard sizes known in the industry (e.g., outermost diameter of 2⅜ inches to 4.5 inches) for standard and commonly known casing sizes (e.g., outermost diameter of 4½ inches to 12 inches), each of which have lengths in the tens to hundreds of feet. The production tubing 220 includes a plurality of tubulars tubing joints, pup joints, etc. At least one packer 230 may be located in the annulus 230 between the production tubing 220 and the casing 215.

The production tubing 220 includes at least one flow valve 235, such as a gas lift valve. Each flow valve 235 controls flow of the combination of gas and coated nanoparticles 202 from the annulus 225 into the production tubing 220. There are a number of commercially available flow valve designs with a variety of shapes, sizes, functionalities, and other characteristics. The different types of flow valve designs include gravity differential flow valves, differential pressure flow valves, and flow valves controlled mechanically and/or electrically by operators at the surface 260. For example, differential flow valves are designed to open due to the difference in gravity or pressure of fluid in the production tubing 220 and fluid in the annulus 225, and they may be used to allow the combination of gas and coated nanoparticles 202 in the annulus 225 to flow into the production tubing 220. Each flow valve 235 may be located outside along the production tubing 220 or in pockets inside the production tubing 200. Each flow valve 235 may be located at a different depth on the production tubing 220 to allow optimization of the gas lift operation, such that a lower or higher depth flow valve 235 may be selected by the operator as desired for optimization. Three flow valves 235 are illustrated in FIG. 2A, but a different quantity of the flow valve 235 may be utilized in other embodiments.

The flow valves 235 may be substantially made of fabricated stainless steel that feature monel/tungsten carbide seats and tungsten carbide stem tips. The flow valves 235 may be designed as modular to achieve low cost deployment and repair. The flow valves 235 may feature spring or nitrogen-charged bellows that provide pressure to maintain the flow valves 235 in closed position when the gas lift operation is not being performed.

In one embodiment, injecting the combination of gas and coated nanoparticles 202 into the wellbore 205 during the gas lift operation comprises (a) injecting the combination of gas and coated nanoparticles 202 into the annulus 225 of the wellbore 205 (e.g., through the injection string 226) and (b) injecting the combination of gas and coated nanoparticles 202 into the production tubing 220 of the wellbore 205 from the annulus 225 of the wellbore 205. In one embodiment, the production tubing 220 comprises at least one flow valve 235, and the combination of gas and coated nanoparticles 202 is injected into the production tubing 220 of the wellbore 205 from the annulus 225 of the wellbore 205 through the at least one flow valve 235. The arrows in FIG. 2A illustrate the fluid flow.

Each gas lift operation can be intermittent or continuous. For intermittent injection, gas is injected into the wellbore intermittently so that reservoir fluid accumulates in the production tubing between each cycle of injection. If the wellbore's conditions permit continuous flow, then continuous injection may be employed. For continuous injection, gas is injected continuously and one or more of the flow valve(s) remain open. The combination of gas and coated nanoparticles 202 may be injected during an intermittent gas lift operation or a continuous gas lift operation into the annulus 225, through the at least one valve 235, and into the production tubing 220. Those of ordinary skill in the art will appreciate the combination of gas and coated nanoparticles 202 may be injected during the intermittent gas lift operation or the continuous gas lift operation without shutting in the wellbore 205 to soak it (and without the halted hydrocarbon production and delay that accompany a shut-in).

Regarding concentration of the coated nanoparticles, in one embodiment, engineers or field personnel may utilize their expertise to determine the concentration of the coated nanoparticles in the combination of gas and coated nanoparticles 202 to be injected during the intermittent gas lift operation or the continuous gas lift operation. Alternatively, or additionally, the combination of gas and coated nanoparticles 202 may be injected during the intermittent gas lift operation or the continuous gas lift operation responsive to the asphaltene content in the produced fluids 245.

At least one sensor 250 in fluid communication with the produced fluids 245 is utilized to generate surveillance data 255 that indicates asphaltene content in the produced fluids 245. The sensor 250 may be installed on the surface 260. The sensor 250 measures or detects asphaltene content in the produced fluids 245. For example, the sensor 250 may be coupled to a wellhead 265 that is in fluid communication with the wellbore 205, coupled to a flowline 270 that is in fluid communication with the wellhead 265, or any combination thereof. In one embodiment, the sensor 250 may be installed inline. In one embodiment, the sensor 250 may operate in real time or near real time.

Practically any sensor configured to measure or detect asphaltene content in the produced fluids 245 may be utilized. For example, the surveillance data 255 may comprise electron paramagnetic resonance (EPR) asphaltene response. The sensor 250 may measure or detect asphaltene content in the produced fluids 245, the sensor 250 may transmit data (e.g., raw data) wirelessly or via a wired connection to a computing system (e.g., a computer), and the transmitted data may be optionally processed (e.g., signal processing, clean up, combining data, generating diagrams, etc.). The surveillance data 255 may include any of this data, such as the raw data, the processed data, or practically any data indicating asphaltene content in the produced fluids 245.

The surveillance data 255 may indicate the asphaltene content, qualitatively, in the produced fluids 245 via a yes or no answer (e.g., yes answer when the asphaltene content is above zero in the produced fluids 245), etc. Alternatively, or additionally, the surveillance data 255 may indicate the asphaltene content, quantitatively, in the produced fluids 245 via one or more numerical values (e.g., zero ppm of asphaltenes in the produced fluids 245, at least 0.0005 weight percent (e.g., 0.1 to 0.5 weight percent or higher) of asphaltenes in the produced fluids 245, a graph such a graph indicating an increasing trend of asphaltene content, etc.), etc.

With the surveillance data 255, the combination of gas and coated nanoparticles 202 may be injected in the wellbore 205 responsive to asphaltene content in the produced fluids 245. For example, the combination of gas and coated nanoparticles 202 may be injected (a) if asphaltene content is above zero ppm in the produced fluids 245, (b) if asphaltene content is above or equal to a threshold (e.g., the asphaltene content is above or equal to 0.01 weight percent) in the produced fluids 245, or any combination thereof.

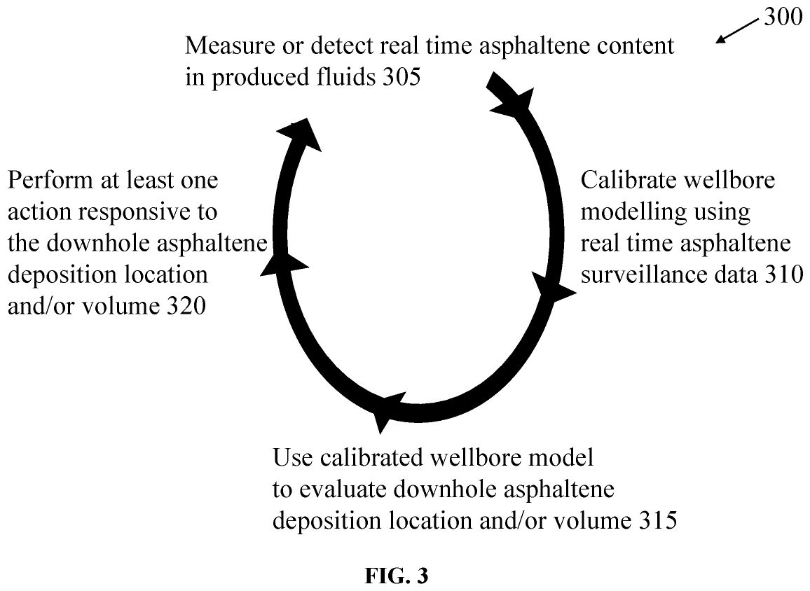

Moreover, with the surveillance data 255, the concentration of the coated nanoparticles in the combination of gas and coated nanoparticles 202 to be injected in the wellbore 205 responsive to the asphaltene content in the produced fluids 245. For example, the concentration of the coated nanoparticles in the combination of gas and coated nanoparticles 202 may be increased in response to an increase in the asphaltene content in the produced fluids 245. For example, if asphaltene content increases by 10%, then the concentration of the coated nanoparticles in the combination of gas and coated nanoparticles may be increased by at least 10%, in other words, 1:1 ratio may be utilized in one embodiment, a 1:2 ratio may be utilized in another embodiment, etc. In the ratio, the first number represents the increase in asphaltenes in the produced fluids 245 and the second number represents the increase in the coated nanoparticles. The concentration of coated nanoparticles may be increased as desired as long as they remain in suspension. As another example, the concentration of the coated nanoparticles in the combination of gas and coated nanoparticles 202 may be decreased in response to a decrease in the asphaltene content in the produced fluids 245. For example, if asphaltene content decreases by 25%, then the concentration of the coated nanoparticles in the combination of gas and coated nanoparticles may be decreased by at least 25%. As another example, the gas may be injected without any coated nanoparticles in response to an asphaltene content of zero, or below or equal to a threshold (e.g., asphaltene content is below 0.01 weight percent), in the produced fluids 245. For example, the gas may be injected without any coated nanoparticles using the wellbore design illustrated in FIG. 2A. FIG. 3 provides more information regarding the sensor 250, the surveillance data 255, and an embodiment of a method of asphaltene surveillance.

Of note, the sensor 250 may be installed in a different location than illustrated in FIG. 2A (e.g., different location on the surface 260 or a location in the subsurface 210). A single sensor 250 on the surface 260 is illustrated for simplicity in FIG. 2A, but some embodiments may include a plurality of the sensor 250.

Returning to FIG. 1, at 110, the method 100 optionally includes injecting an additive into the wellbore during the gas lift operation to increase hydrocarbon production. In one embodiment, the additive comprises a surfactant, a monovalent ion, a multivalent ion, a polymer, or any combination thereof. A number of surfactants such as sodium dodecyl sulfate (SDS), sodium laurilsulfate, sodium lauryl sulfate (SLS), or any combination thereof can be injected. The polymer may be practically any polymer that may be injected into a hydrocarbon-bearing zone. For example, the additive may be injected into the wellbore 205 with the combination of the gas and coated nanoparticles 202 into the annulus 225, through the at least one flow valve 235, and into the production tubing 220 as described hereinabove. For example, the additive may be injected into the wellbore 205 with the gas, with or without the coated nanoparticles, in some embodiments. The quantity of additive that may be injected is 0.0005 to 20 weight percent (e.g., 0.0005 to 5 weight percent) in one embodiment. More information about additives may be found in U.S. Pat. No. 10,266,750, which is incorporated by reference herein.

At 115, the method 100 includes recovering produced fluids through the wellbore. For example, the produced fluids 245 may include at least a portion of the hydrocarbons 240 from the subsurface 210, a least a portion of the injected gas, and/or a least a portion of the injected coated nanoparticles, among others. The produced fluids 245 have a reduced concentration of asphaltenes compared to recovery without injection of the coated nanoparticles, for example, based on the surveillance data 255.

In one embodiment, at 120, the method 100 optionally includes positioning at least one artificial lift device within the production tubing and wherein recovering the produced fluids through the wellbore comprises using the at least one artificial lift device. For example, the produced fluids 245 may be produced through the wellbore 205 using an artificial lift device 260, such as an electric submersible pump (ESP), a progressive cavity pump (PCP), a plunger lift device, etc. The artificial lift device 260 is utilized to lift the produced fluids 245 up the wellbore 205 towards the surface 260.

Those of ordinary skill in the art will appreciate that various modifications may be made to the embodiments provided herein. For example, one or more of 105, 110, 115, or 120 may be repeated depending on the embodiment. For example, the embodiments discussed herein are applicable to a wellbore 290 with a horizontal trajectory (sometimes referred to as a horizontal wellbore) as illustrated in FIG. 2C. Other modifications may also become apparent.

Soaking/Shut-in: It is worth noting that if asphaltenes have clogged one or more of the flow valves 235, then some or all of the combination of gas and coated nanoparticles 202 may not be able to flow from the annulus 225 into the production tubing 220 to reduce the asphaltenes in the produced fluids 245.

As such, at 125, the method 100 optionally includes injecting at least one chemical agent into the production tubing and soaking the wellbore with the at least one chemical agent for a period of time (e.g., to unclog one or more of the flow valves 235, etc.). For example, the wellbore 205 may be soaked with the at least one chemical agent for a period of time and the wellbore 205 is shut-in during that period of time. The wellbore 205 may be shut-in while soaking for at least 3 hours in one embodiment, at least 8 hours in a second embodiment, or at least 24 hours in a third embodiment, 3 to 6 hours in a fourth embodiment, or 6 to 24 hours in a fifth embodiment. The wellbore 205 may even be shut-in while soaking for a plurality of days, such as 1 day up to 30 days, or a sufficient amount of days to reduce the asphaltene content. Injecting the at least one chemical agent into the production tubing 220 may reduce asphaltene clogging in one or more of the flow valves 235, as well as reduce the asphaltene content in the produced fluids 245, reduce asphaltene coating on one or more surfaces of the production tubing 220, etc.

As illustrated in FIG. 1, soaking may be performed before 105 of the method 100 to increase the likelihood that each flow valve 235 is unobstructed so that the combination of gas and coated nanoparticles 202 can flow from the annulus 225 into the production tubing 220. However, soaking may be performed at any time, such as, but not limited to, soaking if the asphaltene content in the produced fluids 245 is above or equal to a threshold (e.g., above or equal to a threshold of 0.01 weight percent) per the surveillance data 255, soaking if the injection rate of the gas without or without coated nanoparticles decreases and suggests that less gas with or without coated nanoparticles is able to flow into the production tubing 220, etc. For example, asphaltene content of about 20 weight percent content may lead to a shut-in of the wellbore 205 to perform a soak operation to reduce the asphaltenes (or injection of a high volume of coated nanoparticles).

In one embodiment, the wellbore 205 may be soaked once during the intermittent gas lift operation or the continuous gas lift operation. In one embodiment, the wellbore 205 may be soaked a plurality of times during the intermittent gas lift operation or the continuous gas lift operation. Even if the wellbore 205 is soaked/shut-in, those of ordinary skill in the art may appreciate that the wellbore 205 may be ultimately soaked fewer times than conventional methods due to injection of the combination of gas and coated nanoparticles 202. After soaking and shutting in, the combination of gas and coated nanoparticles may be injected from the annulus 225 into the production tubing 220 via the at least one flow valve 235 as described in the embodiments herein.

Practically any chemical agent that dissolves or breaks up asphaltenes may be utilized for soaking. In one embodiment, the chemical agent comprises xylene, toluene, or any combination thereof. The quantity of chemical agent that may be injected is 0.0005 to 20 weight percent (e.g., 0.0005 to 5 weight percent) in one embodiment. In one embodiment, at 125, at least one chemical injection tubing, such as the chemical injection tubing 280 illustrated in FIG. 2B, is positioned within the production tubing 220 to inject the at least one chemical agent into the production tubing 220 to soak the wellbore 205 for the period of time.

Turning to FIG. 3, this figure illustrates an embodiment of a method of asphaltene surveillance referred to as a method 300. At 305, the method 300 includes measuring or detecting in real time (or near real time) asphaltene content in the produced fluids 245 from the wellbore 205 using the sensor 250. By doing so, real time surveillance data 255 may be generated using the sensor 250. For example, real-time surface measurement of percentage of asphaltene flowing from the wellbore 205 may be provided in the real time surveillance data 255.

At 310, the method 300 includes calibrating wellbore modelling using the real time surveillance data 255. For example, one or more models, such as a wellbore model, may be calibrated. For example, a wellbore simulation model may be calibrated to the real-time surface measured percentage of asphaltene in the produced fluids 245.

At 315, the method 300 includes using the calibrated wellbore model to evaluate downhole asphaltene deposition location, volume, or any combination thereof. For example, the calibrated wellbore simulation model may be used to evaluate downhole wellbore conditions of pressure, temperature, and gas-oil-ratio, as well as extent of asphaltene formation in the oil stream. The downhole simulation calibration can be performed with commercial software in one embodiment.

At 320, the method 300 includes performing at least one action responsive to the downhole asphaltene deposition location, volume, or any combination thereof. For example, the at least on action may include adjusting concentration of the coated nanoparticles in the combination of gas and coated nanoparticles 202, such as increasing or decreasing (e.g., decreasing the coated nanoparticles down to zero ppm in some embodiments) the concentration of the coated nanoparticles as discussed hereinabove. For example, the calibrated model data may be used to guide the execution of asphaltene remediation by injecting the combination of gas and coated nanoparticles 202 with or without an additive (e.g., a surfactant) to increase hydrocarbon production.

Embodiments: Embodiment 1. A method of reducing asphaltenes in produced fluids from a wellbore, the method comprising: injecting a combination of gas and coated nanoparticles into a wellbore during a gas lift operation, wherein the coated nanoparticles adsorb asphaltenes in the wellbore, thereby inhibiting asphaltene deposition, reducing asphaltene molecule interaction, reducing agglomeration of asphaltenes, or any combination thereof; and recovering produced fluids through the wellbore.

Embodiment 2. The method of Embodiment 1, wherein injecting the combination of gas and coated nanoparticles into the wellbore during the gas lift operation comprises injecting the combination of gas and coated nanoparticles into an annulus of the wellbore and injecting the combination of gas and coated nanoparticles into a production tubing of the wellbore from the annulus of the wellbore.

Embodiment 3. The method of Embodiment 2, wherein the production tubing comprises at least one flow valve, and wherein the combination of gas and coated nanoparticles is injected into the production tubing of the wellbore from the annulus of the wellbore through the at least one flow valve.

Embodiment 4. The method of any of Embodiments 1-3, further comprising positioning at least one artificial lift device within the production tubing, and wherein recovering the produced fluids through the wellbore comprises using the at least one artificial lift device.

Embodiment 5. The method of any of Embodiments 1-4, further comprising: injecting at least one chemical agent into the production tubing; and soaking the wellbore with the at least one chemical agent for a period of time.

Embodiment 6. The method of any of Embodiments 1-5, further comprising injecting an additive into the wellbore during the gas lift operation to increase hydrocarbon production.

Embodiment 7. The method of any of Embodiments 1-6, wherein the combination of gas and coated nanoparticles are injected into the wellbore responsive to asphaltene content in the produced fluids.

Embodiment 8. The method of Embodiment 7, wherein surveillance data indicates the asphaltene content in the produced fluids.

Embodiment 9. The method of any of Embodiments 1-8, wherein the gas comprises produced gas, carbon dioxide, natural gas, methane, ethane, nitrogen, propane, butane, flue gas, exhaust gas, or any combination thereof.

Embodiment 10. The method of any of Embodiments 1-9, wherein the coated nanoparticles are at a concentration of at least 5 ppm in the combination of gas and coated nanoparticles.

Embodiment 11. The method of any of Embodiments 1-10, wherein the coated nanoparticles are surface coated with an acidic coating.

Embodiment 12. The method of any of Embodiments 1-10, wherein the coated nanoparticles are surface coated with a basic coating.

Embodiment 13. The method of any of Embodiments 1-10, wherein the coated nanoparticles are surface coated with a neutral coating.

Embodiment 14. The method of any of Embodiments 1-10, wherein the coated nanoparticles comprise iron oxide, magnetite, iron octanoate, or any combination thereof, wherein each of the coated nanoparticles is coated by functionalizing with alkylphenol resins, aldehyde resins, sulfonated resins, polyolefin esters, amides, imides with alkyl, alkylenephenyl functional group, alkylenepyridyl functional groups, alkenyl and vinylpyrrolidone copolymers, graft polymers of polyolefins, hyperbranched polyester amides, lignosulfonates, alkylaromatics, alkylaryl sulfonic acids, phosphoric esters, phosphinocarboxylic acids, sarcosinates, amphoteric surfactants, ether carboxylic acids, aminoalkylene carboxylic acids, alkylphenols and ethoxylates, imidazolines and alkylamide-imidazolines, alkyl succinimides, alkylpyrrolidones, fatty acid amides and ethoxylates thereof, fatty esters of polyhydric alcohols, ion-pair salts of imines and organic acids, triethyl amine groups, triethanolamine lauryl ether sulfate, linear and branched dodecyl benzene sulfonic acid (DBSA), polymers with protic polar heads, or any combination thereof.

Embodiment 15. A system of reducing asphaltenes in produced fluids from a wellbore, the system comprising: a wellbore drilled into a subsurface reservoir; and a combination of gas and coated nanoparticles injected into the wellbore during a gas lift operation, wherein the coated nanoparticles adsorb asphaltenes in the wellbore, thereby inhibiting asphaltene deposition, reducing asphaltene molecule interaction, reducing agglomeration of asphaltenes, or any combination thereof; and wherein produced fluids are recovered through the wellbore.

Embodiment 16. The system of Embodiment 15, wherein the wellbore further comprises an annulus that receives the combination of gas and coated nanoparticles injected into the wellbore, and further comprising a production tubing positioned within the wellbore that receives the combination of gas and coated nanoparticles from the annulus.

Embodiment 17. The system of Embodiment 16, wherein the production tubing further comprises at least one flow valve, and wherein the combination of gas and coated nanoparticles is received by the production tubing of the wellbore from the annulus through the at least one flow valve.

Embodiment 18. The system of any of Embodiments 15-17, further comprising at least one artificial lift device positioned within the production tubing that is utilized to recover the produced fluids through the wellbore.

Embodiment 19. The system of any of Embodiments 15-18, further comprising at least one chemical agent and at least one chemical injection tubing positioned within the production tubing to inject the at least one chemical agent into the production tubing to soak the wellbore for a period of time.

Embodiment 20. The system of any of Embodiments 15-19, further comprising at least one sensor in fluid communication with the produced fluids that is utilized to generate surveillance data indicative of asphaltene content in the produced fluids.

The methods of the appended claims are not limited in scope by the specific methods described herein, which are intended as illustrations of a few aspects of the claims. Any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of reducing asphaltenes in produced fluids from a wellbore, the method comprising:
injecting a combination of gas and coated nanoparticles into a wellbore during a gas lift operation, wherein the coated nanoparticles adsorb asphaltenes in the wellbore, thereby inhibiting asphaltene deposition, reducing asphaltene molecule interaction, reducing agglomeration of asphaltenes, or any combination thereof; and
recovering produced fluids through the wellbore.

2. The method of claim 1, wherein injecting the combination of gas and coated nanoparticles into the wellbore during the gas lift operation comprises injecting the combination of gas and coated nanoparticles into an annulus of the wellbore and injecting the combination of gas and coated nanoparticles into a production tubing of the wellbore from the annulus of the wellbore.

3. The method of claim 2, wherein the production tubing comprises at least one flow valve, and wherein the combination of gas and coated nanoparticles is injected into the production tubing of the wellbore from the annulus of the wellbore through the at least one flow valve.

4. The method of claim 2, further comprising positioning at least one artificial lift device within the production tubing, and wherein recovering the produced fluids through the wellbore comprises using the at least one artificial lift device.

5. The method of claim 2, further comprising:
injecting at least one chemical agent into the production tubing; and
soaking the wellbore with the at least one chemical agent for a period of time.

6. The method of claim 1, further comprising injecting an additive into the wellbore during the gas lift operation to increase hydrocarbon production.

7. The method of claim 1, wherein the combination of gas and coated nanoparticles are injected into the wellbore responsive to asphaltene content in the produced fluids.

8. The method of claim 7, wherein surveillance data indicates the asphaltene content in the produced fluids.

9. The method of claim 1, wherein the gas comprises produced gas, carbon dioxide, natural gas, methane, ethane, nitrogen, propane, butane, flue gas, exhaust gas, or any combination thereof.

10. The method of claim 1, wherein the coated nanoparticles are at a concentration of at least 5 ppm in the combination of gas and coated nanoparticles.

11. The method of claim 1, wherein the coated nanoparticles are surface coated with an acidic coating.

12. The method of claim 1, wherein the coated nanoparticles are surface coated with a basic coating.

13. The method of claim 1, wherein the coated nanoparticles are surface coated with a neutral coating.

14. The method of claim 1, wherein the coated nanoparticles comprise iron oxide, magnetite, iron octanoate, or any combination thereof, wherein each of the coated nanoparticles is coated by functionalizing with alkylphenol resins, aldehyde resins, sulfonated resins, polyolefin esters, amides, imides with alkyl, alkylenephenyl functional group, alkylenepyridyl functional groups, alkenyl and vinylpyrrolidone copolymers, graft polymers of polyolefins, hyperbranched polyester amides, lignosulfonates, alkylaromatics, alkylaryl sulfonic acids, phosphoric esters, phosphinocarboxylic acids, sarcosinates, amphoteric surfactants, ether carboxylic acids, aminoalkylene carboxylic acids, alkylphenols and ethoxylates, imidazolines and alkylamide-imidazolines, alkylsuccinimides, alkylpyrrolidones, fatty acid amides and ethoxylates thereof, fatty esters of polyhydric alcohols, ion-pair salts of imines and organic acids, triethyl amine groups, triethanolamine lauryl ether sulfate, linear and branched dodecyl benzene sulfonic acid (DBSA), polymers with protic polar heads, or any combination thereof.

15. A system of reducing asphaltenes in produced fluids from a wellbore, the system comprising:
a wellbore drilled into a subsurface reservoir; and
a combination of gas and coated nanoparticles injected into the wellbore during a gas lift operation, wherein the coated nanoparticles adsorb asphaltenes in the wellbore, thereby inhibiting asphaltene deposition, reducing asphaltene molecule interaction, reducing agglomeration of asphaltenes, or any combination thereof; and
wherein produced fluids are recovered through the wellbore.

16. The system of claim 15, wherein the wellbore further comprises an annulus that receives the combination of gas and coated nanoparticles injected into the wellbore, and further comprising a production tubing positioned within the wellbore that receives the combination of gas and coated nanoparticles from the annulus.

17. The system of claim 16, wherein the production tubing further comprises at least one flow valve, and wherein the combination of gas and coated nanoparticles is received by the production tubing of the wellbore from the annulus through the at least one flow valve.

18. The system of claim 16, further comprising at least one artificial lift device positioned within the production tubing that is utilized to recover the produced fluids through the wellbore.

19. The system of claim 16, further comprising at least one chemical agent and at least one chemical injection tubing positioned within the production tubing to inject the at least one chemical agent into the production tubing to soak the wellbore for a period of time.

20. The system of claim 15, further comprising at least one sensor in fluid communication with the produced fluids that is utilized to generate surveillance data indicative of asphaltene content in the produced fluids.
